(19) United States
(12) Patent Application Publication
(10) Pub. No.: US 2011/0074996 A1
(43) Pub. Date: Mar. 31, 2011

(54) CCD IMAGE SENSORS WITH VARIABLE OUTPUT GAINS IN AN OUTPUT CIRCUIT

(76) Inventors: Shen Wang, Webster, NY (US); Christopher Parks, Rochester, NY (US)

(21) Appl. No.: 12/568,696

(22) Filed: Sep. 29, 2009

(51) Int. Cl. H04N 5/335

(52) U.S. Cl. 348/311; 348/E05.091

(57) ABSTRACT

An output circuit in a charge-coupled device (CCD) image sensor includes a charge-to-voltage conversion region, a gain control transistor connected to the charge-to-voltage conversion region and a reset transistor connected in series with the gain control transistor. One or more additional gain control transistors can be connected between the reset transistor and the gain control transistor. The one or more gain control transistors are used to set a capacitance of the charge-to-voltage conversion region to two or more difference capacitance levels. For each capacitance level, a reset voltage and a signal voltage are measured from the charge-to-voltage conversion region. A signal processing device computes multiple signal values for a single charge packet using the measured reset and signal voltages. The signal processing device selects one of the multiple signal values to be the signal value for the pixel.

### TECHNICAL FIELD

The present invention relates generally to image sensors for use in digital cameras and other types of image capture devices, and more particularly to Charge-Coupled-Device (CCD) image sensors.

### BACKGROUND

A CCD image sensor typically includes an array of photosensitive areas that collect charge carriers in response to light striking each photosensitive area. This charge is then read out of the array to a horizontal shift register and an output circuit. FIG. 1 is a schematic diagram of an output circuit for a CCD image sensor in accordance with the prior art. Output circuit 100 includes output gate transistor 102 electrically connected between node 104 and a CCD shift register (HCCD) (not shown). Charge-to-voltage conversion region 106, reset transistor 108, and a gate of amplifier transistor 110 are also connected to node 104. Charge-to-voltage conversion region 106 and amplifier transistor 110 convert the charge to an analog voltage signal Vₒᵤₜ.

Charge-to-voltage conversion region 106 has a capacitance that is fixed at a given capacitance level. The capacitance determines the voltage change on node 104 through the well known relation ΔQ=CΔV, where ΔQ represents the amount of charge transferred onto the charge-to-voltage conversion region 106 from the CCD shift register, C the capacitance of the charge-to-voltage conversion region 106, and ΔV the change in voltage of the charge-to-voltage conversion region 106. The charge-to-voltage conversion region 106 cannot hold an unlimited amount of charge. The output amplifier transistor 110 also cannot handle an unlimited voltage change on its gate. If those limits are exceeded, image detail will be lost in bright areas. To avoid those limits camera image exposure times are shortened to reduce the signal. The shortened exposure times will degrade image detail in dark areas of an image.

One method to avoid the limits of the output amplifier transistor 110 and charge-to-voltage conversion region 106 is to provide a method of changing the capacitance of the charge-to-voltage conversion region 106. Several techniques have been used to change the capacitance of a charge-to-voltage conversion region or node in Complementary Metal Oxide Semiconductor (CMOS) image sensors. U.S. Pat. No. 6,730,897 increases the capacitance level of a floating diffusion node by adding a capacitor connected between the floating diffusion and ground. U.S. Pat. No. 6,960,796 increases the capacitance level of a floating diffusion node by adding a capacitor connected between the floating diffusion and a power supply VDD. These prior art structures increase the floating diffusion node capacitance sufficiently to ensure the maximum output voltage is within the power supply limit at maximum photodiode charge capacity. However, these prior art solutions may not be optimum for low light level conditions. When there is a very small amount of charge in the photodiode, the larger floating diffusion capacitance lowers the voltage output, thereby making it more difficult to measure the small signals.

In FIG. 6 in U.S. Pat. No. 7,427,790 two reset transistors are used to vary the capacitance level of a charge-to-voltage conversion region included in each pixel in the CMOS image sensor. Charge is collected by a photosensitive area in a pixel. The capacitance of a charge-to-voltage conversion region in the pixel is set to one level and the charge is sensed by the charge-to-voltage conversion region. A voltage signal is then output from the pixel. The photosensitive area then collects newly generated charge, the capacitance of the charge-to-voltage conversion region is set to a different level, and the newly collected charge is sensed by the charge-to-voltage conversion region. A second voltage signal is the output from the pixel. This technique requires the photosensitive area to capture two different images, and in some situations, the voltage signals output from the same pixel may differ. If one or more objects in the scene being imaged quickly shifts position in the time between the two images, or if the lighting conditions change in the time between images, the amount of charge collected for the first image can differ from the amount of charge collected for the second image.

United States Patent Application 2008/0231727 discloses a method of changing the capacitance of the charge-to-voltage conversion region with charge summing (binning) transistors. The same charge packet is read twice with the capacitance of the charge-to-voltage conversion region set to two different capacitances to extend the dynamic range of the output. This requires a CMOS type image sensor that shares excess charge between the charge-to-voltage conversion region and a photodiode. Such an arrangement is not possible with a CCD image sensor because the charge-to-voltage conversion region is connected to a CCD shift register and not a photodiode.

### SUMMARY

A charge-coupled device (CCD) image sensor includes an imaging area having a plurality of pixels, a vertical CCD shift register adjacent to each column of pixels, a horizontal CCD shift register for receiving charge packets from the vertical CCD shift registers, and an output circuit connected to the horizontal CCD shift register. The output includes a charge-to-voltage conversion region, a gain control transistor connected to the charge-to-voltage conversion region, and a reset transistor connected in series with the gain control transistor. A timing generator produces a gain control signal that has two or more signal values. The gain control signal is applied to a gate of the gain control transistor to set a capacitance of the charge-to-voltage conversion region to two or more respective capacitance levels. For each capacitance level, a reset voltage and a signal voltage are measured from the charge-to-voltage conversion region. A signal processing device computes multiple signal values for a single charge packet using the measured reset and signal voltages. The signal processing device selects one of the multiple signal values to be the signal value for the pixel.

A method for producing a signal value for a pixel included in the CCD image sensor includes setting a capacitance of the charge-to-voltage conversion region in the output circuit to a first capacitance level by receiving a gain control signal having a first signal value on a gate of the gain control transistor. The charge-to-voltage conversion region is then reset to a known potential. While the capacitance of the charge-to-voltage conversion region is at the first capacitance level, a first reset voltage of the charge-to-voltage conversion region is measured. The capacitance of the charge-to-voltage conversion region in the output circuit is then set to a second capacitance level by receiving the gain control signal having a second signal value on a gate of the gain control transistor. A second reset voltage of the charge-to-voltage conversion region is measured while the capacitance of the charge-to-voltage conversion region is at the second capacitance level.

A single charge packet accumulated by the pixel is then transferred to the charge-to-voltage conversion region in the output circuit while the capacitance of the charge-to-voltage conversion region is at the second capacitance level. A first signal voltage of the charge-to-voltage conversion region is measured while the capacitance of the charge-to-voltage conversion region is at the second capacitance level. The capacitance of the charge-to-voltage conversion region in the output circuit is then set to the first capacitance level and a second signal voltage is measured while the capacitance of the charge-to-voltage conversion region is at the first capacitance level. A first gain signal is computed by subtracting the first reset voltage from the second signal voltage. A second gain signal is computed by subtracting the second reset voltage from the first signal voltage. One of the two gain signals is selected as the signal value for the pixel. The method repeats for each charge packet read out of the imaging area. The selected signal values for at least a portion of the pixels can be multiplied by a gain ratio.

### BRIEF DESCRIPTION OF THE DRAWINGS

Embodiments of the invention are better understood with reference to the following drawings. The elements of the drawings are not necessarily to scale relative to each other.

FIG. 1 is a schematic diagram of an output circuit for a CCD image sensor in accordance with the prior art;

FIG. 2 is a block diagram of an image capture device in an embodiment in accordance with the invention;

FIG. 3 is a top view of image sensor 208 shown in FIG. 2 in an embodiment in accordance with the invention;

FIGS. 4A-4B illustrate a flowchart of a method for producing a signal value for a pixel in an embodiment in accordance with the invention;

FIG. 5 is a schematic diagram of a first output circuit suitable for use as output circuit 316 shown in FIG. 3 in an embodiment in accordance with the invention;

FIG. 6 is a block diagram of two output channels that receive output signals from output circuit 316 shown in FIGS. 3 and 5 in an embodiment in accordance with the invention;

FIG. 7 is an exemplary chart showing the relationship between V₁ and V₂ and the charge packet size from a pixel in the CCD image sensor;

FIG. 8 is a timing diagram for the operation of output circuit 316 shown in FIG. 5 in an embodiment in accordance with the invention;

FIG. 9 is a schematic diagram of a second output circuit suitable for use as output circuit 316 shown in FIG. 3 in an embodiment in accordance with the invention; and

FIG. 10 is a schematic diagram of a third output circuit suitable for use as output circuit 316 shown in FIG. 3 in an embodiment in accordance with the invention.

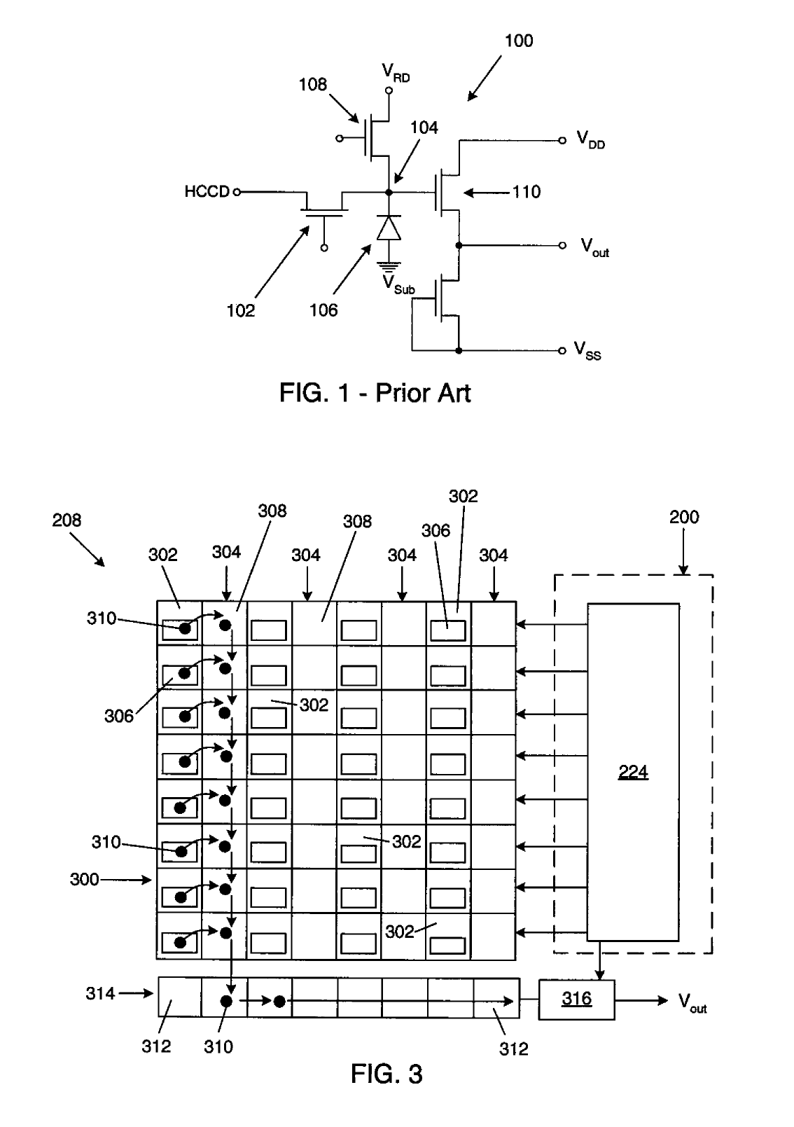

### ADVANTAGEOUS EFFECTS

One advantage of the present invention is the ability to set the capacitance of a charge-to-voltage conversion region in an output circuit of a CCD image sensor to multiple capacitance levels. The sensitivity and dynamic range of the CCD image sensor can therefore be increased.

### DETAILED DESCRIPTION

Throughout the specification and claims the following terms take the meanings explicitly associated herein, unless the context clearly dictates otherwise. The meaning of “a,” “an,” and “the” includes plural reference, the meaning of “in” includes “in” and “on.” The term “connected” means either a direct electrical connection between the items connected or an indirect connection through one or more passive or active intermediary devices. The term “circuit” means either a single component or a multiplicity of components, either active or passive, that are connected together to provide a desired function. The term “signal” means at least one current, voltage, or data signal.

Additionally, directional terms such as “on”, “over”, “top”, “bottom”, “left”, “right”, are used with reference to the orientation of the Figure(s) being described. Because components of embodiments of the present invention can be positioned in a number of different orientations, the directional terminology is used for purposes of illustration only and is in no way limiting. When used in conjunction with layers of an image sensor wafer or corresponding image sensor, the directional terminology is intended to be construed broadly, and therefore should not be interpreted to preclude the presence of one or more intervening layers or other intervening image sensor features or elements. Thus, a given layer that is described herein as being formed on or formed over another layer may be separated from the latter layer by one or more additional layers.

And finally, the terms “wafer” and “substrate” are to be understood as a semiconductor-based material including, but not limited to, silicon, silicon-on-insulator (SOI) technology, doped and undoped semiconductors, epitaxial layers formed on a semiconductor substrate, and other semiconductor structures.

Referring to the drawings, like numbers indicate like parts throughout the views.

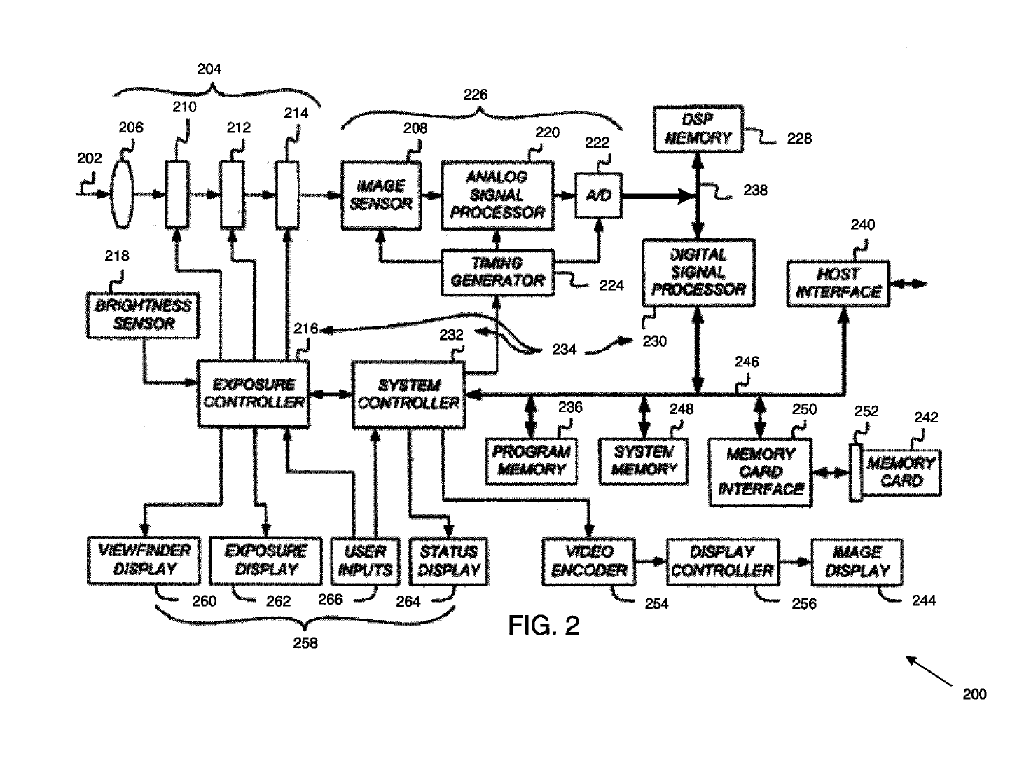

FIG. 2 is a block diagram of an image capture device in an embodiment in accordance with the invention. Image capture device 200 is implemented as a digital camera in FIG. 2, but the present invention is applicable to other types of image capture devices. Examples of different types of image capture device include, but are not limited to, a scanner, a digital video camera, and mobile or portable devices that include one or more cameras.

Light 202 from the subject scene is input to an imaging stage 204, where the light is focused by lens 206 to form an image on image sensor 208. Image sensor 208 converts the incident light to an electrical signal for each picture element (pixel). Image sensor 208 is implemented as a charge coupled device (CCD) image sensor in an embodiment in accordance with the invention. The pixels in image sensor 208 have a color filter array (CFA) (not shown) applied over the pixels so that each pixel senses a portion of the imaging spectrum in an embodiment in accordance with the invention.

The light passes through the lens 206 and filter 210 before being sensed by image sensor 208. Optionally, light 202 passes through a controllable iris 212 and a mechanical shutter 214. The filter 210 comprises an optional neutral density (ND) filter for imaging brightly lit scenes. The exposure controller block 216 responds to the amount of light available in the scene as metered by the brightness sensor block 218 and regulates the operation of filter 210, iris 212, shutter 214, and the integration time (or exposure time) of image sensor 208 to control the brightness of the image as sensed by image sensor 208.

This description of a particular camera configuration will be familiar to one skilled in the art, and it will be obvious that many variations and additional features are, or can be, present. For example, an autofocus system can be added, or the lenses can be detachable and interchangeable. It will be understood that the present invention is applied to any type of digital camera, where similar functionality is provided by alternative components. For example, the digital camera can be a relatively simple point and shoot digital camera, where shutter 214 is a relatively simple movable blade shutter, or the like, instead of a more complicated focal plane arrangement as is found in a digital single lens reflex camera. The present invention can also be practiced on imaging components included in simple camera devices such as mobile phones and automotive vehicles which can be operated without controllable irises 212 and without mechanical shutters 214. Lens 206 can be a fixed focal length lens or a zoom lens.

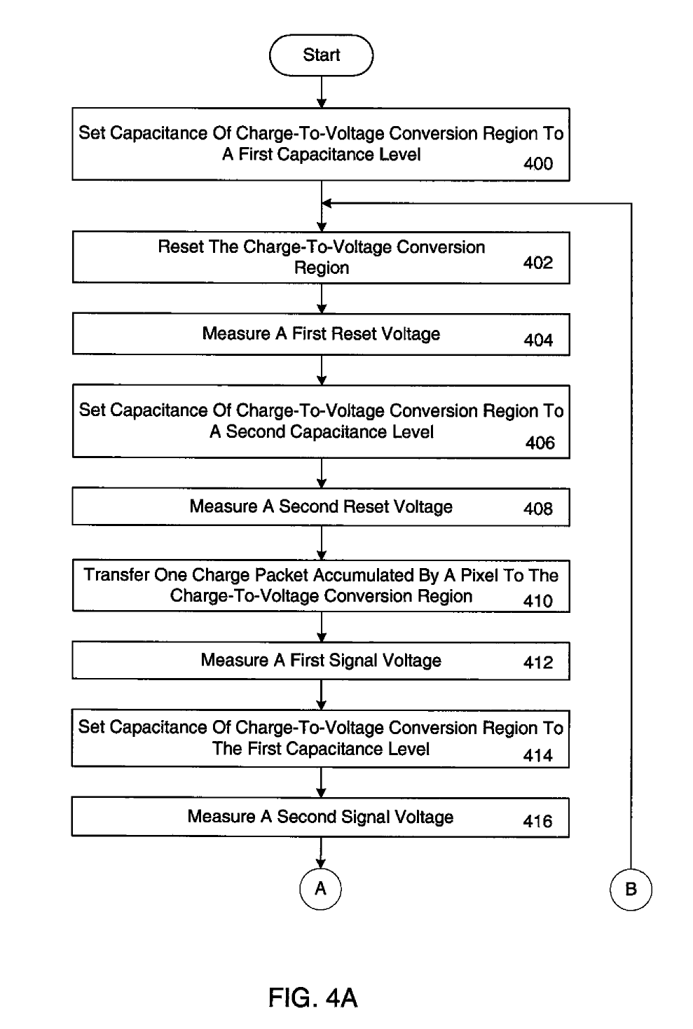

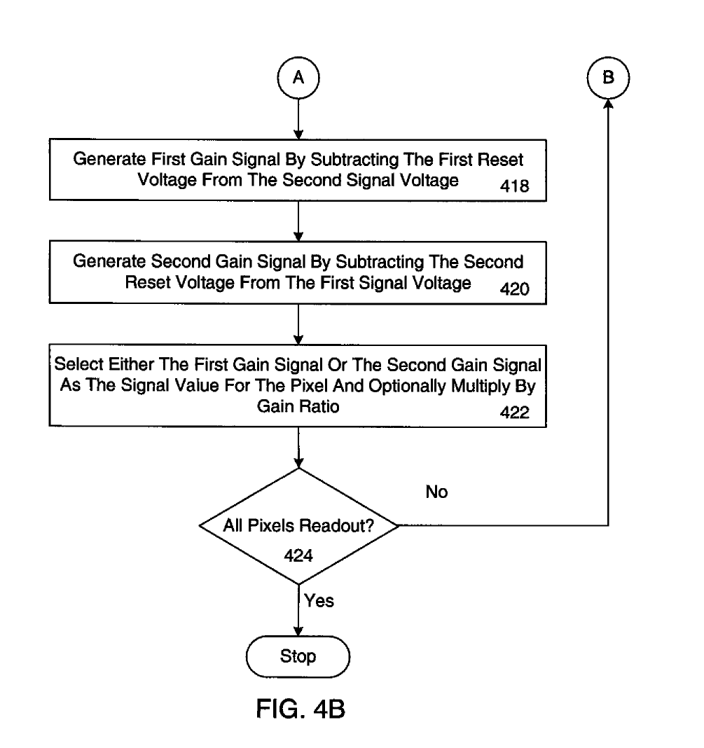

The analog signal from image sensor 208 is processed by analog signal processor 220 and applied to one or more analog to digital (A/D) converters 222. Timing generator 224 produces various clocking signals to select rows, columns, or pixels in image sensor 208, to transfer charge out of image sensor 208, and to synchronize the operations of analog signal processor 220 and A/D converter 222. Timing generator 224 also produces a gain control signal having two or more different signal values that will be described later with respect to FIG. 4.

The image sensor stage 226 includes image sensor 208, analog signal processor 220, analog-to-digital (A/D) converter 222, and timing generator 224. The components of image sensor stage 226 are separately fabricated integrated circuits, or some or all of the components are fabricated as a single integrated circuit as is commonly done with Complementary Metal Oxide Semiconductor (CMOS) image sensors. The resulting stream of digital pixel values from A/D converter 222 is stored in memory 228 associated with digital signal processor (DSP) 230.

Digital signal processor 230 is one of three processors or controllers in this embodiment, in addition to system controller 232 and exposure controller 216. Although this partitioning of camera functional control among multiple controllers and processors is typical, these controllers or processors are combined in various ways without affecting the functional operation of the camera and the application of the present invention. These controllers or processors can comprise one or more digital signal processor devices, microcontrollers, programmable logic devices, or other digital logic circuits. Although a combination of such controllers or processors has been described, it should be apparent that one controller or processor can be designated to perform all of the needed functions. All of these variations can perform the same function and fall within the scope of this invention, and the term “processing stage” will be used as needed to encompass all of this functionality within one phrase, for example, as in processing stage 234 in FIG. 2.

In the illustrated embodiment, DSP 230 manipulates the digital image data in memory 228 according to a software program stored in program memory 236 and copied to memory 228 for execution during image capture. DSP 230 executes the software necessary for image processing in an embodiment in accordance with the invention. Memory 228 includes any type of random access memory, such as SDRAM. Bus 238 comprising a pathway for address and data signals connects DSP 230 to its related memory 228, A/D converter 222 and other related devices.

System controller 232 controls the overall operation of the camera based on a software program stored in program memory 236, which can include Flash EEPROM or other nonvolatile memory. This memory can also be used to store image sensor calibration data, user setting selections and other data which must be preserved when the camera is turned off. System controller 232 controls the sequence of image capture by directing exposure controller 216 to operate lens 206, filter 210, iris 212, and shutter 214 as previously described, directing timing generator 224 to operate image sensor 208 and associated elements, and directing DSP 230 to process the captured image data. After an image is captured and processed, the final image file stored in memory 228 is transferred to a host computer via interface 240, stored on a removable memory card 242 or other storage device, and displayed for the user on image display 244.

Bus 246 includes a pathway for address, data and control signals, and connects system controller 232 to DSP 230, program memory 236, system memory 248, host interface 240, memory card interface 250 and other related devices. Host interface 240 provides a high speed connection to a personal computer (PC) or other host computer for transfer of image data for display, storage, manipulation or printing. This interface is an IEEE1394 or USB2.0 serial interface or any other suitable digital interface. Memory card 242 is typically a Compact Flash (CF) card inserted into socket 252 and connected to system controller 232 via memory card interface 250. Other types of storage that are utilized include without limitation PC-Cards, MultiMedia Cards (MMC), or Secure Digital (SD) cards.

Processed images are copied to a display buffer in system memory 248 and continuously read out via video encoder 254 to produce a video signal. This signal is output directly from camera 200 for display on an external monitor, or processed by display controller 256 and presented on image display 244. This display is typically an active matrix color liquid crystal display (LCD), although other types of displays are used as well.

User interface 258, including all or any combination of viewfinder display 260, exposure display 262, status display 264, and image display 244, and user inputs 266, is controlled by a combination of software programs executed on exposure controller 216 and system controller 232. User inputs 266 typically include some combination of buttons, rocker switches, joysticks, rotary dials or touch screens. Exposure controller 216 operates light metering, exposure mode, autofocus and other exposure functions. System controller 232 manages the graphical user interface (GUI) presented on one or more of the displays, e.g., on image display 244. The GUI typically includes menus for making various option selections and review modes for examining captured images.

Exposure controller 216 accepts user inputs selecting exposure mode, lens aperture, exposure time (shutter speed), and exposure index or ISO speed rating and directs the lens and shutter accordingly for subsequent captures. Optional brightness sensor 218 is employed to measure the brightness of the scene and provide an exposure meter function for the user to refer to when manually setting the ISO speed rating, aperture and shutter speed. In this case, as the user changes one or more settings, the light meter indicator presented on viewfinder display 260 tells the user to what degree the image will be over or underexposed. In an alternate case, brightness information is obtained from images captured in a preview stream for display on image display 244. In an automatic exposure mode, the user changes one setting and exposure controller 216 automatically alters another setting to maintain correct exposure, e.g., for a given ISO speed rating when the user reduces the lens aperture, exposure controller 216 automatically increases the exposure time to maintain the same overall exposure.

The foregoing description of a digital camera will be familiar to one skilled in the art. It will be obvious that there are many variations of this embodiment that are possible and are selected to reduce the cost, add features or improve the performance of the camera.

The image sensor 208 shown in FIG. 2 typically includes a two-dimensional array of light sensitive pixels fabricated on a silicon substrate that provides a way of converting incoming light at each pixel into an electrical signal that is measured. As the sensor is exposed to light, free charge carriers (i.e., charge or charge packets) are collected and stored within the photosensitive area in each pixel. Capturing these free charge carriers for some period of time and then measuring the number of charge carriers captured, or measuring the rate at which free charge carriers are generated, measures the light level at each pixel.

FIG. 3 is a top view of image sensor 208 shown in FIG. 2 in an embodiment in accordance with the invention. Image sensor 208 includes an imaging area 300 having a two-dimensional array of pixels 302 and a vertical charge-coupled device (VCCD) shift register 304 positioned adjacent to each column of pixels. Each pixel 302 includes one or more photosensitive areas 306. Each VCCD shift register 304 includes a column of charge storage elements 308, with one or more charge storage elements associated with each pixel in a column of pixels.

Charge 310 accumulates in each photosensitive area 306 in response to light striking the imaging area 300. To read out an image captured by image sensor 208, appropriate bias voltage signals are generated by timing generator 224 (see FIG. 2) and applied to transfer regions or gates (not shown) disposed between the photosensitive areas 306 and respective charge storage elements 308. This causes the charge 310 to transfer from the photosensitive areas 306 to the charge storage elements 308. The charge 310 in all of the VCCDs 304 is then shifted in parallel one row at a time into charge storage elements 312 in horizontal CCD (HCCD) shift register 314. Each row of charge 310 is then shifted serially one charge storage element 312 at a time through HCCD shift register 314 to output circuit 316. Output circuit 316 converts the charge 310 collected by a photosensitive area 306 into an analog voltage output signal (Vₒᵤₜ) having four or more different voltage levels in an embodiment in accordance with the invention.

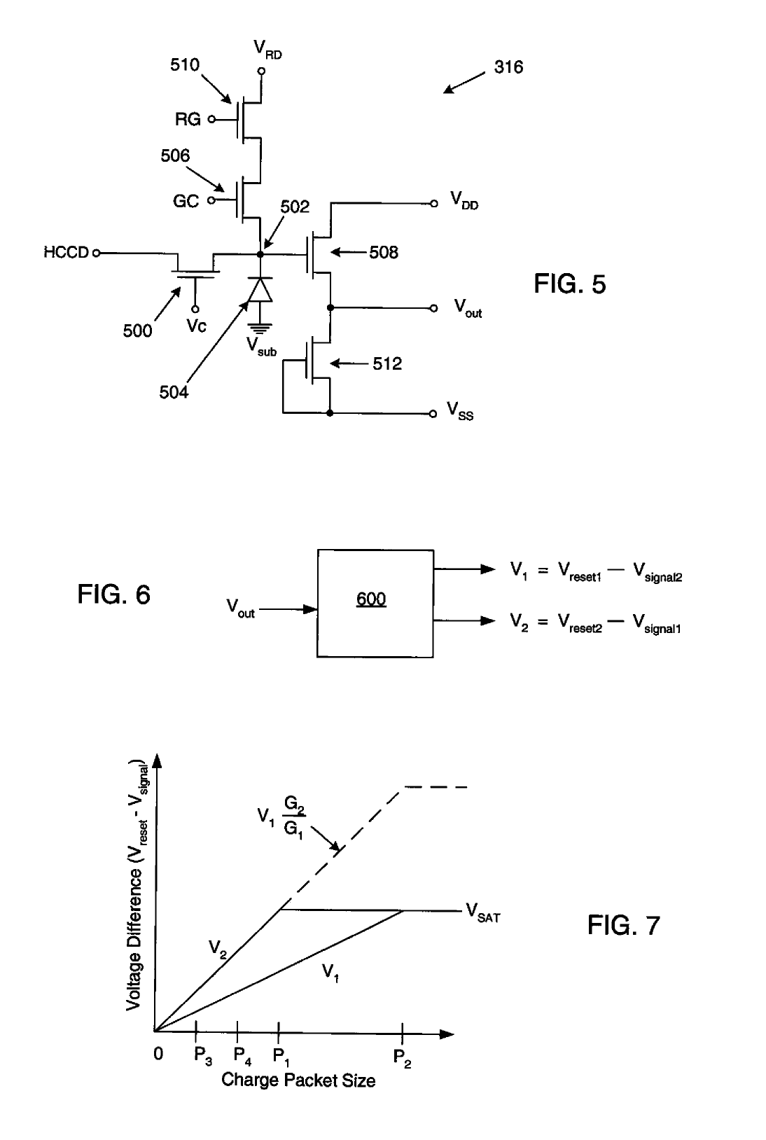

Timing generator 224 (FIG. 2) also produces a gain control signal having two different signal values that are used to change the gain of output circuit 316 in an embodiment in accordance with the invention. FIG. 4 is a flowchart of a method for producing a signal value for a pixel in an embodiment in accordance with the invention. Initially, the capacitance of a charge-to-voltage conversion region included in the output circuit is set to a first capacitance level (block 400). The first capacitance level is set by applying the gain control signal having a first signal value to the gate of a gain control transistor, as described in conjunction with FIGS. 5, 9, and 10. By way of example only, the capacitance of the charge-to-voltage conversion region can be set to a high capacitance level at block 400. The high capacitance level corresponds to a low gain mode for the output circuit 316 (FIG. 3). Once the first capacitance level is set, the charge-to-voltage conversion region is reset (block 402) and a first reset voltage is measured on the charge-to-voltage conversion region in the output circuit (block 404).

Next, the charge-to-voltage conversion region is set to a second capacitance level (block 406) and a second reset voltage is measured on the charge-to-voltage conversion region in the output circuit (block 408). Continuing with the example in the previous paragraph, the capacitance level of the charge-to-voltage conversion region is now set to a low capacitance level at block 406. The low capacitance level corresponds to a high gain mode for the output circuit 316.

A single charge packet that was accumulated by a single pixel is then transferred to the charge-to-voltage conversion region (block 410) and a first signal voltage is measured while the charge-to-voltage conversion region is set at the second capacitance level (block 412). Next, as shown in block 414, the capacitance of the charge-to-voltage conversion region is set to the first capacitance level and a second signal voltage is measured while the charge-to-voltage conversion region is set to the first capacitance level (block 416).

The charge packet may be too large to be contained by the charge-to-voltage conversion region when the capacitance of the charge-to-voltage conversion region is set at a lower capacitance level. Changing the capacitance of the charge-to-voltage conversion region allows more of the charge in the charge packet to be contained by the charge-to-voltage conversion region. Unlike prior art CMOS image sensors, no additional clocking of the CCD is needed for this to take place. Moreover, with a CCD image sensor, a charge packet can be measured multiple times once the charge packet is stored on the charge-to-voltage conversion region in the output circuit. Thus, the capacitance of the charge-to-voltage conversion region can be set to more than two different capacitance levels in other embodiments in accordance with the invention.

Returning to FIG. 4, a first gain signal is generated by subtracting the first reset voltage from the second signal voltage, as shown in block 418. A second gain signal is then produced by subtracting the second reset voltage from the first signal voltage (block 420). Thus, in the FIG. 4 embodiment, one possible signal value that corresponds to the first capacitance level of the charge-to-voltage conversion region is produced for a pixel and another possible signal value that corresponds to the second capacitance level of the charge-to-voltage conversion region is generated for the same pixel. Other embodiments in accordance with the invention can generate more than two possible signal values for a single pixel when the capacitance of the charge-to-voltage conversion region is set to more than two different capacitance levels.

One of the two different signal values is then selected as the signal value for the pixel, and the selected signal value is then optionally multiplied by a gain ratio, as shown in block 422. By way of example only, analog signal processor 220 shown in FIG. 2 can be used to compute the differences for the two signal values, to select one of the two signal values, and to execute the multiplication if performed. The gain ratio is described in more detail in conjunction with FIG. 7.

A determination is then made at block 424 as to whether or not the charge packets from all of the pixels have been readout. If not, the process returns to block 402 and repeats until all of the charge packets, or all of the desired charge packets, are readout from the image sensor.

Referring now to FIG. 5, there is shown a schematic diagram of a first output circuit suitable for use as output circuit 316 shown in FIG. 3 in an embodiment in accordance with the invention. Output circuit 316 includes a CCD output gate transistor 500 electrically connected between node 502 and the last charge storage element in HCCD shift register 314 (see FIG. 3). The gate of CCD output gate transistor 500 is connected to a constant voltage source V. Charge-to-voltage conversion region 504, the gain control transistor 506, and a gate of amplifier transistor 508 are also connected to node 502. Charge-to-voltage conversion region 504 is implemented as a floating diffusion in an embodiment in accordance with the invention.

The gain control transistor 506 and the reset transistor 510 are connected in series between node 502 and voltage source (V_{RD}). The amplifier transistor 508 is connected between voltage source V_{DD} and output node (Vₒᵤₜ). And finally, transistor 512 is connected between output node Vₒᵤₜ and voltage source V_{SS}. The operation of output circuit 316 will be described later with reference to FIG. 8.

FIG. 6 is a block diagram of a signal processing device that receives the output voltage Vₒᵤₜ from output circuit 316 shown in FIGS. 3, 5, 9, and 10 in an embodiment in accordance with the invention. The signal processing device 600 measures the first reset voltage Vᵣₑₛₑₜ₁, second reset voltage Vᵣₑₛₑₜ₂, first signal voltage V_{signal1}, and second signal voltage V_{signal2}. Signal processing device 600 also computes the signal values V₁ and V₂ for a pixel, where V₁=V_{signal2}−Vᵣₑₛₑₜ₁ and V₂=V_{signal1}−Vᵣₑₛₑₜ₂. The differences may be computed using analog or digital subtraction methods. The signal values V₁ and V₂ are directly proportional to the size of the same charge packet obtained from a single pixel in the CCD image sensor. As noted earlier, analog signal processor 220 shown in FIG. 2 can be used to compute the differences for the two signal values and to select one of the two signal values.

FIG. 7 is an exemplary chart showing the relationship between V₁ and V₂ and the charge packet size from a pixel in the CCD image sensor. Curve V₂ is measured with the charge-to-voltage region set to a small capacitance to provide a high gain measurement in one embodiment in accordance with the invention. The slope of curve V₂ is the gain G₂. Curve V₁ is measured with the charge-to-voltage region set to a large capacitance to provide a low gain measurement. The slope of curve V₁ is the gain G₁. Both curves cannot rise above the saturation voltage (V_{SAT}) of the amplifier transistor 508 (see FIG. 5). If a charge packet is measured with only gain G₂, then the charge packet will have a measurable maximum size at point P1, because P1 is the packet size located at the intersection of curve V₂ and V_{SAT}. With gain G₂, small signal levels have a better signal to noise ratio than small signals measured with gain G₁, but large signal levels are lost at gain G₂ because the packet sizes quickly equal the saturation voltage V_{SAT}. By also measuring the same charge packet with a gain of G₁ it is possible to extend the dynamic range of the system out to charge packets of size P2, where the curve V₁ intersects with V_{SAT}. With gain G_{I}, charge packets have a greater range of possible sizes because curve V₁ intersects with V_{SAT} at size P₂ instead of size P₁.

If the charge packet size is smaller than P₁, the signal processing device 600 outputs the signal V₂ for a pixel. If the charge packet size is larger than P1, the signal processing device 600 outputs the signal

$${V}_{1} \frac{{G}_{2}}{{G}_{1}}$$

for a pixel. By scaling the V₁ signal by the ratio of gains, the linear output range of curve V₂ can be extended past the saturation limit V_{SAT}.

If the charge packets being measured were generated by an imaging array, such as the exemplary array of pixels 302 in imaging area 300, then the gain ratio

$$\frac{{G}_{2}}{{G}_{1}}$$

can be determined directly from the image data. For a range of charge packets smaller than P1, the data from both curves V1 and V2 will be valid. The gain ratio will then be equal to

$$\frac{{G}_{2}}{{G}_{1}} = \frac{{V}_{2}}{{V}_{1}} .$$

More than one pixel can be used to collect a large number of values for the gain ratio to reduce the statistical uncertainty of the gain ratio. In one embodiment, the charge package size range between P₃ and P₄ is used to obtain the gain ratio

$$\frac{{G}_{2}}{{G}_{1}} .$$

Using the range between P₃ and P₄ can avoid too much noise at low signal end for V_{I}, or a saturated signal at high signal end for V₂.

Referring now to FIG. 8, there is shown a timing diagram for the operation of output circuit 316 shown in FIG. 5. The timing signals are described with reference to producing an analog output signal for a single charge packet by setting the capacitance of the charge-to-voltage conversion region to two different capacitance levels. Those skilled in the art will recognize that the timing signals repeat for each charge packet read out of the imaging area 300 (FIG. 3).

At a time right before t₁, a gain control signal (GC) having a first signal value is applied to the gate of the gain control transistor 506 (FIG. 5). At time t₁, a reset signal (RG) is applied to the gate of the reset transistor 510 (FIG. 5) to set the potential of the charge-to-voltage conversion region 504 to the known potential V. Since the gain control transistor 506 is turned on, the capacitance of the charge-voltage conversion region 504 is set at a first particular capacitance level.

At time t₂, the RG signal transitions to a low state, turning off reset transistor 510. At this point, the first reset voltage is measured from the charge-to-voltage conversion region 504.

At time t₃, the GC signal transitions to a different signal value to set the capacitance of the charge-to-voltage conversion region to a second capacitance level. At this point, the second reset voltage is measured on the charge-to-voltage conversion region 504.

At time t₄, the last charge storage element 312 in horizontal CCD 314 (FIG. 3) is clocked with signal H to transfer a charge packet from the last charge storage element to the charge-to-voltage conversion region 504 through output gate transistor 500. Then a first signal voltage is measured on the charge-to-voltage conversion region 504.

At time t₅, the GC signal turns on gain control transistor 506 to set the capacitance of the charge-to-voltage conversion region to the first capacitance level. The second signal voltage is then measured from the charge-to-voltage conversion region.

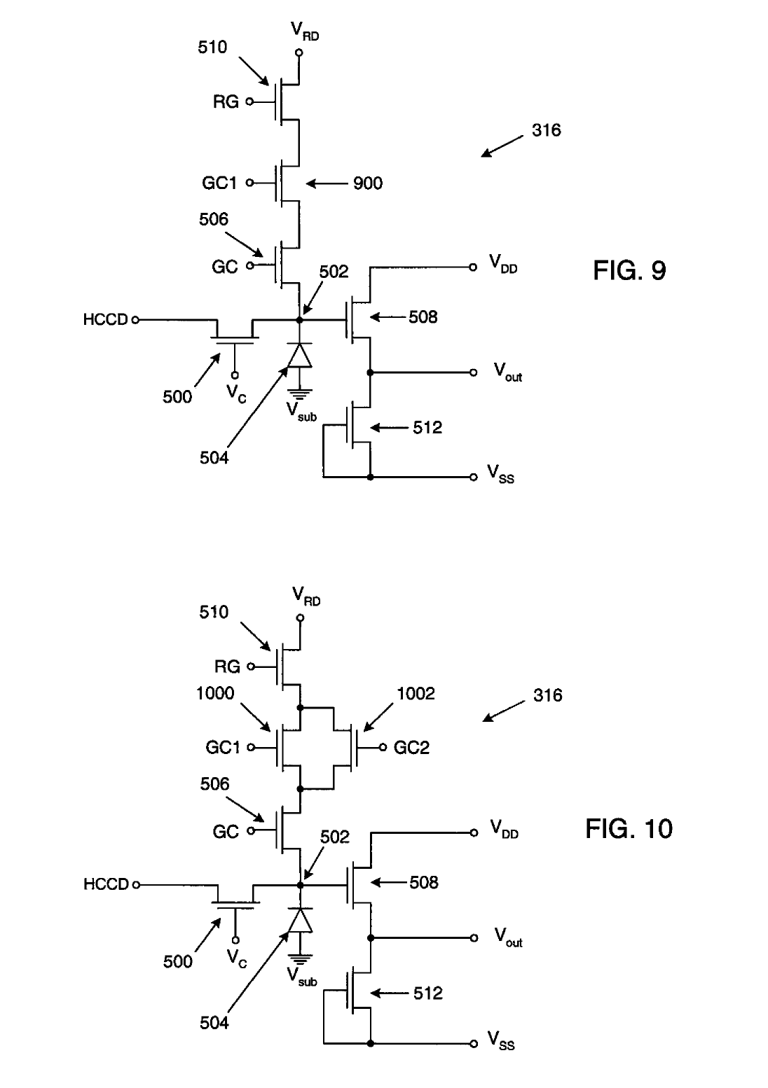

The invention has been described in detail with particular reference to certain embodiments thereof, but it will be understood that variations and modifications can be effected within the spirit and scope of the invention. For example, it is possible to have more than two levels of capacitance in the charge-voltage conversion region by having more than one gain control transistor connected in series with each other. FIG. 9 is a schematic diagram of a second output circuit suitable for use as output circuit 316 shown in FIG. 3 in an embodiment in accordance with the invention. An additional gain control transistor 900 is connected in series between the reset transistor 510 and gain control transistor 506.

It is possible to have more levels of capacitance in the charge-voltage conversion regions by having more than one gain control transistor connected in parallel with each other in place of the present one gain control transistor. FIG. 10 is a schematic diagram of a third output circuit suitable for use as output circuit 316 shown in FIG. 3 in an embodiment in accordance with the invention. FIG. 10 depicts two additional gain control transistors, i.e., 1000 and 1002 connected in parallel between reset transistor 510 and gain control transistor 506.

Other aspects associated with the output circuit will change accordingly based on the circuit configurations shown in FIGS. 9 and 10. For example, timing generator 224 will have more than one gain control signal for the embodiments shown in FIGS. 9 and 10. Alternatively, other embodiments in accordance with the invention can employ multiple timing generators to produce these signals.

Additionally, even though specific embodiments of the invention have been described herein, it should be noted that the application is not limited to these embodiments. In particular, any features described with respect to one embodiment may also be used in other embodiments, where compatible. And the features of the different embodiments may be exchanged, where compatible.

### PARTS LIST

100 output charge sensing circuit
102 output gate transistor
104 node
106 charge-to-voltage conversion region
108 reset transistor
110 amplifier transistor
200 image capture device
202 light
204 imaging stage
206 lens
208 image sensor
210 filter
212 iris
214 shutter
216 exposure controller
218 brightness sensor
220 analog signal processor
222 analog-to-digital converter
224 timing generator
226 image sensor stage
228 Digital Signal Processor (DSP) memory
230 Digital Signal Processor
232 system controller
234 processing stage
236 program memory
238 bus
240 host interface
242 memory card
244 display
246 bus
248 system memory
250 memory card interface
252 socket
254 video encoder
256 display controller
258 user interface
260 viewfinder display
262 exposure display
264 status display
266 user inputs
300 imaging area
302 pixel
304 vertical charge-coupled device (VCCD) shift register
306 photosensitive area
308 charge storage element
310 charge
312 charge storage element
314 horizontal charge-coupled device (HCCD) shift register
316 output circuit
500 output gate transistor
502 node
504 charge-to-voltage conversion region
506 gain control transistor
508 amplifier transistor
510 reset transistor
512 transistor
600 signal processing device
900 gain control transistor
1000 gain control transistor
1002 gain control transistor

What is claimed is:

1. A method for producing a signal value for a pixel included in a charge-coupled device (CCD) image sensor having an output circuit that comprises a charge-to-voltage conversion region, a gain control transistor connected to the charge-to-voltage conversion region, and a reset transistor connected in series with the gain control transistor, the method comprising:
(a) setting a capacitance of the charge-to-voltage conversion region in the output circuit to a first capacitance level;
(b) resetting the charge-to-voltage conversion region;
(c) measuring a first reset voltage of the charge-to-voltage conversion region in the output circuit while the capacitance of the charge-to-voltage conversion region is at the first capacitance level;
(d) setting the capacitance of the charge-to-voltage conversion region in the output circuit to a second capacitance level;
(e) measuring a second reset voltage of the charge-to-voltage conversion region while the capacitance of the charge-to-voltage conversion region is at the second capacitance level;
(f) transferring a single charge packet accumulated by the pixel to the charge-to-voltage conversion region in the output circuit while the capacitance of the charge-to-voltage conversion region is at the second capacitance level;
(g) measuring a first signal voltage of the charge-to-voltage conversion region while the capacitance of the charge-to-voltage conversion region is at the second capacitance level;
(h) setting the capacitance of the charge-to-voltage conversion region in the output circuit to the first capacitance level; and
(i) measuring a second signal voltage of the charge to voltage conversion region while the capacitance of the charge-to-voltage conversion region is at the first capacitance level.

2. The method of claim 1, further comprising repeating (b) through (i) for each pixel readout of the CCD image sensor.

3. The method of claim 1, further comprising:
(j) subtracting the first reset voltage from the second signal voltage to generate a first gain signal; and
(k) subtracting the second reset voltage from the first signal voltage to generate a second gain signal.

4. The method of claim 3, further comprising (l) for each pixel, selecting a signal value from either the first gain signal or the second gain signal.

5. The method of claim 4, further comprising (m) multiplying the selected signal value by a gain ratio for at least a portion of the pixels.

6. A method for producing a signal value for a pixel in a charge-coupled-device (CCD) image sensor having an output circuit that receives charge packets from a CCD shift register, wherein the output circuit includes a charge-to-voltage conversion region, a gain control transistor connected to the charge-to-voltage conversion region, and a reset transistor connected in series with the gain control transistor, the method comprising:
(a) setting a capacitance of the charge-to-voltage conversion region in the output circuit to a first capacitance level by receiving a gain control signal having a first signal value on a gate of the gain control transistor;
(b) resetting the charge-to-voltage conversion region;
(c) measuring a first reset voltage of the charge-to-voltage conversion region in the output circuit while the capacitance of the charge-to-voltage conversion region is at the first capacitance level;
(d) setting the capacitance of the charge-to-voltage conversion region in the output circuit to a second capacitance level by receiving the gain control signal having a second signal value on a gate of the gain control transistor;
(e) measuring a second reset voltage of the charge-to-voltage conversion region while the capacitance of the charge-to-voltage conversion region is at the second capacitance level;
(f) transferring a single charge packet accumulated by the pixel to the charge-to-voltage conversion region in the output circuit while the capacitance of the charge-to-voltage conversion region is at the second capacitance level;
(g) measuring a first signal voltage of the charge-to-voltage conversion region while the capacitance of the charge-to-voltage conversion region is at the second capacitance level;
(h) setting the capacitance of the charge-to-voltage conversion region in the output circuit to the first capacitance level;
(i) measuring a second signal voltage of the charge to voltage conversion region while the capacitance of the charge-to-voltage conversion region is at the first capacitance level;
(j) subtracting the first reset voltage from the second signal voltage to generate a first gain signal; and
(k) subtracting the second reset voltage from the first signal voltage to generate a second gain signal; and
(l) selecting a signal value from either the first gain signal or the second gain signal.

7. The method of claim 6, further comprising repeating (a) through (l) for each pixel readout of the CCD image sensor.

8. The method of claim 7, further comprising (m) multiplying the selected signal value by a gain ratio for at least a portion of the pixels.
